(19) United States
(12) Patent Application Publication
(10) Pub. No.: US 2012/0257706 A1
(43) Pub. Date: Oct. 11, 2012

(54) REACTOR VESSEL INTERNALS RADIATION ANALYSES

(75) Inventors: Gianluca Longoni, Pittsburgh, PA (US); Arnold H. Fero, New Kensington, PA (US); Stanwood L. Anderson, Pittsburgh, PA (US); Gregory Alan Fischer, Pittsburgh, PA (US)

(73) Assignee: Westinghouse Electric Company LLC, Cranberry Township, PA (US)

(21) Appl. No.: 13/081,805

(22) Filed: Apr. 7, 2011

(51) Int. Cl. G21C 17/108

(52) U.S. Cl. 376/254

(57) ABSTRACT

The present invention relates to a computational system and method to analyze a radiation field in a light water nuclear reactor. The system and method include a radiation transport module for performing a neutron and gamma transport calculation of a reactor geometry model of the light water nuclear reactor for at least one fuel cycle; a material analysis module for analyzing flux data calculated by the radiation transport module for materials and/or components within the light water nuclear reactor; and a mobile component tracking module for calculating radiation exposure for components within the light water nuclear reactor which have more than one different location during or between the at least one fuel cycle.

### FIELD OF THE INVENTION

This invention relates generally to light water nuclear reactors and more particularly, to automated computational systems and methods for analyzing the radiation field in light water nuclear reactors.

### BACKGROUND OF THE INVENTION

Radiation exposure data can be used in assessing and managing various issues relating to the operation of light water nuclear reactors at commercial nuclear plants throughout the world, as well as issues relating to the aging of these light water nuclear reactors. For example, in the Code of Federal Regulations 10CFR50.61, the United States Nuclear Regulatory Commission addresses concerns over potential pressurized thermal shock events in pressurized water nuclear reactors. The pressurized thermal shock parameters calculated for reactor vessel materials are a function of radiation fluence. In another aspect of the operation and aging of light water reactors, reactor vessel internals inspections are performed to identify flaws in reactor internals components. The radiation fluence data is critical in determining whether identified flaws meet acceptance criteria.

Further, the Code of Federal Regulations 10 CFR 50, Appendix G, requires the determination of specific fracture toughness for normal operations and anticipated operational occurrences for nuclear light water reactors. Several replaceable reactor components (e.g., control rod assemblies) are lifetime-limited by cumulative radiation exposure. Radiation fluence data assists in determining whether reactor components are suitable for continued operation or if replacement is necessary.

To address the various aforementioned issues and related issues, it is desirable for the nuclear industry to have available systems and methods to accurately and timely obtain radiation exposure data on plant-, cycle- and location-specific bases. The systems and methods of the present invention provide an automated computer code for efficiently and effectively analyzing the radiation field in light water nuclear reactors to address various operational and aging issues, such as, but not limited to, those mentioned herein.

### SUMMARY OF THE INVENTION

In one aspect, the present invention provides a computational system to analyze a radiation field in a light water nuclear reactor. The computational system includes a radiation transport module to perform a neutron and gamma transport calculation of a reactor geometry model of the light water nuclear reactor for at least one fuel cycle; a material analysis module to analyze flux data calculated by the radiation transport module for materials and/or components within the light water nuclear reactor; and a mobile component tracking module to calculate radiation exposure for components within the light water nuclear reactor which have more than one different location during or between the at least one fuel cycle.

The computational system can solve the Linear Boltzmann Equation. Further, this Equation can be solved using an approach selected from the group consisting of a three-dimensional synthesis, two-dimensional synthesis, and an explicitly three-dimensional formulation.

The computational system can electronically store data generated by the radiation transport module. The electronically stored data can be accessible for use in projected fuel cycles.

The computational system can include a graphical interface for use in entering inputs.

The radiation transport module of the computational system can determine a spatial distribution of neutron and gamma flux radiation fields.

The material analysis module of the computational system can calculate the location of maximum exposure for each specified material or component.

The computational system can further include a three-dimensional contour plots module to generate three-dimensional contour plots of the radiation field using data generated from the radiation transport and materials analysis modules.

The computational system can further include a dosimetry analysis module to compare measured data to the data generated by the radiation transport module.

The mobile component tracking module of the computational system can calculate radiation exposure for a component selected from the group consisting of control rod assemblies and fuel assembly thimble plugs.

In an embodiment, the light water nuclear reactor can be selected from the group consisting of pressurized water reactors and boiling water reactors.

In another aspect, the present invention provides a computational method for analyzing a radiation field in a light water nuclear reactor. The computational method includes performing a neutron and gamma transport calculation of a reactor geometry model of the light water nuclear reactor for at least one fuel cycle; analyzing flux data calculated by the neutron and gamma transport calculation for materials and/or components within the light water nuclear reactor; and calculating radiation exposure for components within the light water nuclear reactor which have more than one different location during or between the at least one fuel cycle.

In still another aspect, the present invention provides a computational method for integrating radiation transport methodologies to produce radiation exposure data for a light water nuclear reactor. The computational method includes performing a neutron and gamma transport calculation of a reactor geometry model of the light water nuclear reactor for at least one fuel cycle; analyzing flux data calculated by the neutron and gamma transport calculation for materials and/or components within the light water nuclear reactor; and calculating radiation exposure for components within the light water nuclear reactor which have more than one different location during or between the at least one fuel cycle.

### BRIEF DESCRIPTION OF THE DRAWINGS

FIG. 1a is a sectional view, with parts cut away, of a two-loop pressurized water nuclear reactor pressure vessel in accordance with an embodiment of the present invention.

FIG. 1b shows a two-dimensional section of the model on the X-Y plane at Z=0.0 cm for a two-loop pressurized water nuclear reactor pressure vessel in accordance with an embodiment of the present invention.

FIG. 2 is a schematic of a graphical user interface for entering data into the radiation transport module in accordance with an embodiment of the present invention.

FIG. 3 is a schematic of a graphical user interface for entering data into the material analysis module in accordance with an embodiment of the present invention.

FIG. 4 is a schematic of a graphical user interface for showing output data (RT-PTS curves) from the material analysis module in accordance with an embodiment of the present invention.

FIG. 5 is a diagram of a Dosimetry Analysis Module input user interface in accordance with an embodiment of the present invention.

FIG. 6 is a diagram of a Mobile Component Tracking Module input user interface in accordance with an embodiment of the present invention.

### DETAILED DESCRIPTION OF THE INVENTION

The computational systems and methods of the present invention include a software tool designed to analyze the radiation environment of a nuclear reactor by integrating various algorithms and providing a user-friendly interface. The algorithms include U.S. Nuclear Regulatory Commission (NRC)-approved radiation transport methodologies. The user interface can be accessed from various computers, such as a laptop or desktop computer, or by directing a remote server to perform the calculations.

The systems and methods of the present invention perform radiation field calculations for a nuclear reactor on plant-specific, cycle-specific and location-specific bases. The geometry of the reactor model, the power history, and the materials properties are used as inputs to the radiation field calculations carried out in accordance with the present invention. These inputs are unique to the specific nuclear reactor being analyzed. The systems and methods of the present invention are applicable to light water nuclear reactors, such as, pressurized water reactors (“PWRs”) and boiling water reactors (“BWRs”). The systems and methods of the present invention are fully customizable to various light water nuclear reactor designs and are not limited based on a particular nuclear reactor design.

In the present invention, the radiation environment within the internals of a PWR or BWR can be analyzed. Reference temperatures for pressurized thermal shock at various pressure vessel locations can be identified and analyzed. Further, radiation data can be projected throughout the life of the reactor. This feature is particularly suited to predict the radiation environment at the end of the plant life time and to possibly extend the life of the plant. With many of the current commercial light water reactors in the United States reaching their operational time limits, the systems and methods of the present invention are particularly useful to accurately monitor, and to predict radiation levels in the future operational life of a nuclear reactor.

In one embodiment, the present invention provides fluence tracking capable of automating complex computational processes related to the calculation of neutron/gamma fluence and associated quantities, such as but not limited to, disintegration per atoms and Reference-Temperature Pressurized Thermal Shock (“RT-PTS”) master curves.

The systems and methods of the present invention employ a software tool or code that is based on a modular approach. Each module is tasked with at least one specific function that is necessary to obtain the desired objective of tracking and projecting neutron exposure within the internals of a light water nuclear reactor. Additional modules can be added to perform additional functions as required by a specific application.

In one embodiment of the present invention, the following modules are included:
Radiation Transport Module
Materials Analysis Module
three-dimensional Contour Plots Module
Dosimetry Analysis Module
Mobile Component Tracking Module

The Radiation Transport Module performs a neutron and gamma transport calculation of the nuclear reactor model being analyzed. The transport calculation is based on the solution of the Linear Boltzmann Equation (LBE) shown in Equation (1).

$$\hat{Ω} \cdot {∇}^{->} {ψ}_{g} ( {r}^{->} , \hat{Ω} ) + {σ}_{g} ( {r}^{->} ) {ψ}_{g} ( {r}^{->} , \hat{Ω} ) = {\sum }_{{g}^{′} = 1}^{G} {\int }_{4 π} d {Ω}^{′} {σ}_{{gg}^{′}} ( {r}^{->} , {\hat{Ω}}^{′} \cdot \hat{Ω} ) {ψ}_{{g}^{′}} ( {r}^{->} , {\hat{Ω}}^{′} ) + \frac{1}{k} {χ}_{g} {\sum }_{{g}^{′} = 1}^{G} v {σ}_{f , {g}^{′}} ( {r}^{->} ) {φ}_{{g}^{′}} ( {r}^{->} ) + {q}_{g}^{e} ( {r}^{->} , \hat{Ω} ) . \qquad Equation ( 1 )$$

The Radiation Transport Module collects all the inputs needed to solve Equation (1) for a specific nuclear reactor model. This module can perform the transport calculation using various known NRC-approved methodologies. In alternate embodiments, this equation can be solved using a three-dimensional synthesis approach, a two-dimensional synthesis approach or an explicitly three-dimensional formulation. For example, the three-dimensional computer codes RAPTOR-M3G or TORT can be used. Alternatively, the two-dimensional radiation transport code DORT can be used.

The transport calculations can be executed interactively or as a background calculation on a remote server, and when the calculation is completed, a notification is sent to the user to inform that the calculation is completed. The notification can be provided in various forms, such as, but not limited to, an email.

The Radiation Transport Module can generate a solution of the neutron and photon radiation field for the nuclear reactor model under analysis for each fuel cycle from the plant startup to current operation. Upon completion of the transport calculation for each fuel cycle, it can be stored (e.g., electronically) to create a library (e.g., on-line) of the transport calculation for each fuel cycle of the analyzed nuclear reactor model. Since past radiation field data is stored and available in the library, it is not necessary to re-perform these past calculations when, for example, a projection of the neutron fluence is requested from the last operating cycle, or any earlier operating cycle provided in the library, to a specified number of years or cycles in the future. This feature allows the systems and methods of the present invention to provide exposure projections at any point in the future by calculating radiation field data for the present cycle or future cycles without the need to re-create past data.

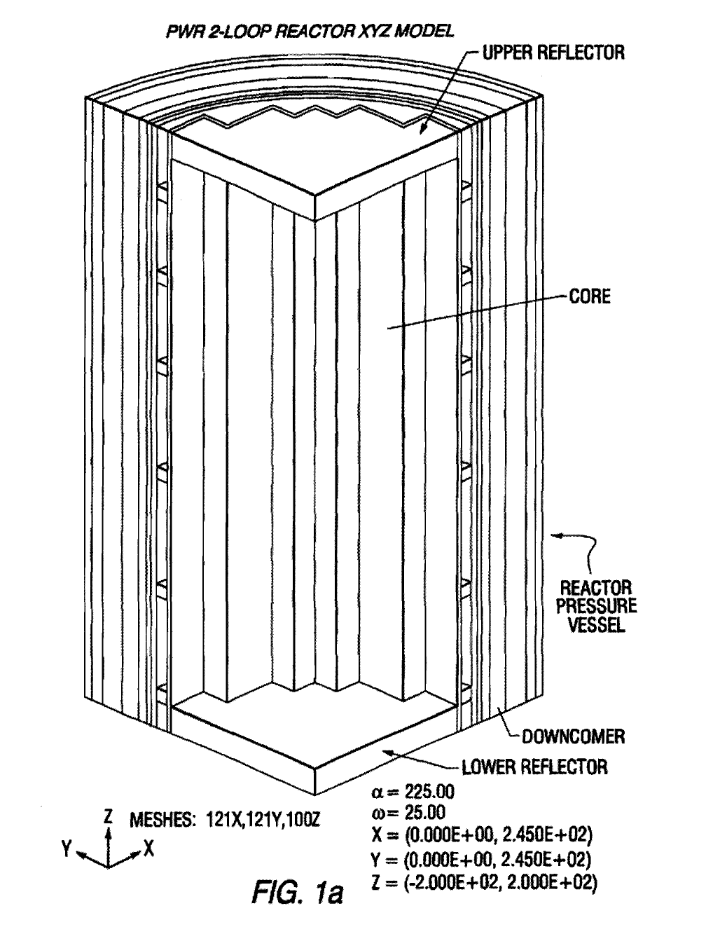

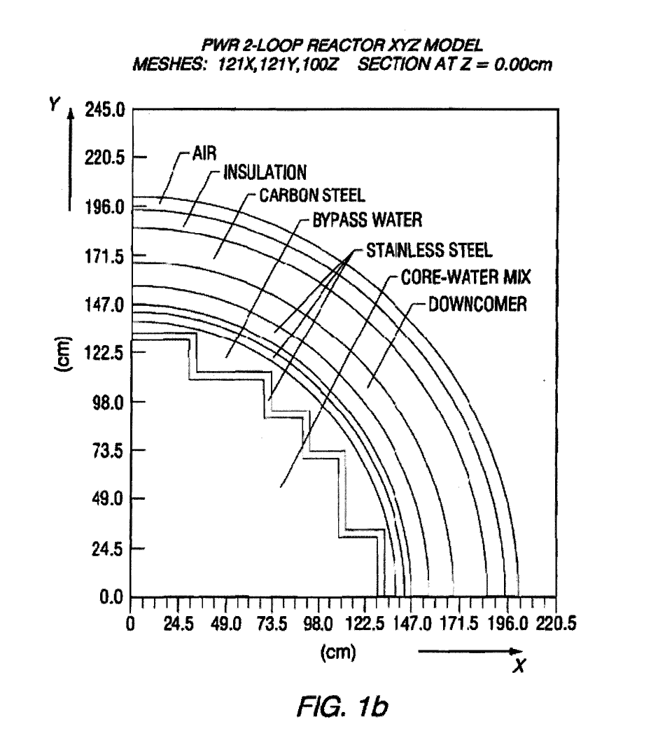

The input data required by the Radiation Transport Model includes the following information:
A model of the reactor geometry and corresponding mesh discretization. This information can be obtained from detailed design drawings of the reactor internals and pressure vessel along with various dimensions. A geometrical model can be rendered using available geometry/mesh modeling tools. A typical geometrical model used in an embodiment of the present invention is demonstrated in FIG. 1a. FIG. 1a shows a typical 3-D transport model of a reactor pressure vessel for a two-loop commercial PWR characterized by a core (e.g., 12 foot core), upper reflector, lower reflector, and downcomer. In an embodiment, the PWR model can include a thermal shield design and a 3-inch reactor cavity air gap. A typical mesh discretization model used in an embodiment of the present invention is demonstrated in FIG. 1b for a two-loop commercial PWR. The model geometry and the mesh discretization can be generated using any geometry modeler and mesh generator known in the art. The model geometry includes a core-water mixture, core shroud, core barrel, thermal shield, Reactor Pressure Vessel (RPV) including stainless-steel liner, and reflective insulation. The upper and lower internals regions above and below the nuclear reactor core are modeled using a steel-water mixture.
A fixed source distribution which defines the spatial and energy characteristics of the neutral particles (including gamma photons) emitted by the nuclear reactor core. The following input is generally needed to prepare a fixed source distribution: radial power distribution, axial power distribution, uranium enrichments, reactor core thermal power level, and coolant temperatures. These inputs represent plant-specific data which is typically measured and recorded at a nuclear power plant. Further inputs can include the following: additional pin-by-pin distributions produced by axis or diagonal reflection of an input pin-by-pin distribution; a multiplicative bias factor to be input by fuel assembly; and relative axial core power distribution by fuel assembly. Based on the aforementioned inputs, the spatial energy variation of the fixed distributed source is determined. The fixed distributed source is then stored, e.g., to a binary file, and it becomes an input parameter for the radiation transport code, e.g., TORT or RAPTOR-M3G or DORT. The fixed source is required for each fuel cycle of the nuclear reactor being analyzed.
Core thermal power for each fuel cycle.
Irradiation time for each cycle, e.g., fuel cycle time.
Cross section data which can be obtained from a library, e.g., electronically stored on a computer. A cross section library can be prepared based on input including but not limited to a suitable broad-group cross-sections library, such as, for example, BUGLE-96; material composition; volume fractions; order of the expansion of the scattering kernel in spherical harmonics; and coolant water temperature and pressure. The BUGLE-96 library, for example, is based on the ENDF/B-VI (Evaluated Nuclear Data File) format libraries. The ENDF format libraries were originally developed in the United States and are controlled by the Cross Section Evaluation Working Group (CSEWG) of the United States Department of Energy and maintained at the National Nuclear Data Center (NNDC) at the Brookhaven National Laboratory. In general, ENDF-format libraries are computer-readable files of nuclear data that describe nuclear reaction cross sections, the distributions in energy and angle of reaction products, the various nuclei produced during nuclear reactions, the decay modes and product spectra resulting from the decay of radioactive nuclei, and the estimated errors in these quantities. The BUGLE-96 library is a 67 energy-group coupled neutron-gamma ray cross section data set (47 neutron, 20 gamma ray) produced specifically for light-water reactor applications.

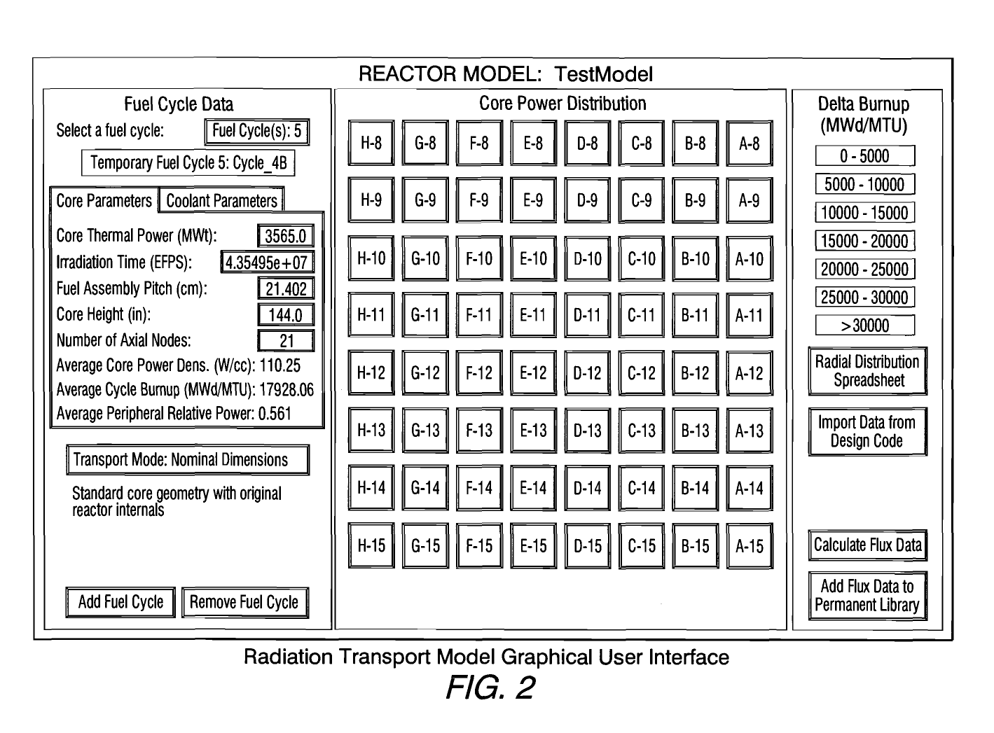

The input data that is supplied by a user for the Radiation Transport Module can be entered using a variety of user-friendly mechanisms known in the art. In one embodiment, a graphical user interface, as shown in FIG. 2, can be used to enter (i) the model of the reactor geometry and corresponding mesh discretization, (ii) the fixed source distribution, (iii) the core thermal power, and (iv) the irradiation time.

The output of the Radiation Transport Module is a set of binary files containing the spatial distribution of the neutron and gamma flux for each energy group corresponding to the cross-section library utilized. These binary files are then utilized by the other modules, e.g., Materials Analysis Module, three-dimensional Contour Plots Module, Dosimetry Analysis Module, and Mobile Component Tracking Module, in accordance with the present invention.

The Materials Analysis Module interrogates the radiation transport solutions obtained using the Radiation Transport Module. Space-and-energy-dependent flux data calculated by the Radiation Transport Module is interrogated by the Materials Analysis Module to retrieve information at the locations of interest. The Materials Analysis Module calculates exposure parameters, such as fast neutron fluence and RT-PTS data, for materials and/or components in a nuclear reactor model. The flux data is combined with response function data according to the equation below:

$$R = {\sum }_{n = 1}^{G} {φ}_{n} {σ}_{n} \qquad Equation ( 2 )$$

wherein:

R=Output response function;

G=Number of energy groups in TORT model;

φₙ=Group n scalar flux; and

σₙ=Group n response function factor.

RT_{NDT} calculations employ the following equations which are codified in the Code of Federal Regulations 10 CFR 50.61:

RT_{NDT}=RT₀+M+ΔRT_{NDT} Equation (3)

RT_{NDT}=Nil-Ductility Reference Temperature;

RT₀=Un-Irradiated Nil-Ductility Temperature;

M=Margin; and

ΔRT_{NDT}=Transition Temperature Shift.

ΔRT_{NDT}=(CF)f^{(0.28-0.10 log f)} Equation (4)

ΔRT_{NDT}=Transition Temperature Shift;

CF=Chemistry Factor; and

Neutron Fluence (E>1.0 MeV).

RT₀, M, and CF are input parameters, and f is calculated. RT_{NDT} can also be calculated according to the Code of Federal Regulations 10 CFR 50.61a using the following equations:

RT_{NDT}=RT₀+ΔT₃₀ Equation (5)

ΔT₃₀=MD+CRP Equation (6)

MD=A×(1−0.001718×T_{C})×(1+6.13×P×Mn^{2.471})×φtₑ^{0.5} Equation (7)

CRP=B×(1+3.77×Ni^{1.191})×f(Cuₑ,P)×g(Cuₑ,Ni,φtₑ) Equation (8)
P [wt-%]=phosphorus content;
Mn [wt-%]=manganese content;
Ni [wt-%]nickel content;
Cu [wt-%]=copper content;
A=1.140×10⁻⁷ for forgings;
   =1.561×10⁻⁷ for plates;
   =1.417×10⁻⁷ for welds;
B=102.3 for forgings;
   =102.5 for plates in non-Combustion Engineering manufactured vessels;
   =135.2 for plates in Combustion Engineering vessels;
   =155.0 for welds;
T_{C}=Cold leg temperature;
φtₑ=φt for φ≧4.39×10¹⁰ n/cm2/sec; and
   =φt×(4.39×10¹⁰/φ)^{0.2595} for φ<4.39×10¹⁰ n/cm2/sec

wherein:
φ [n/cm2/sec]=average neutron flux;
t [sec]=time that the reactor has been in full power operation;
φt [n/cm2]=φ×t;
f(Cue,P)=0 for Cu≦0.072;
   [Cuₑ−0.072]^{0.668} for Cu>0.072 and P≦0.008;
   [Cuₑ−0.072+1.359×(P−0.008)]^{0.668} for Cu>0.072 and P>0.008;
Cuₑ=0 for Cu<0.072;
   =MIN (Cu, maximum Cuₑ) for Cu>0.072;
maximum Cuₑ=0.243 for Linde 80 welds; and
   0.301 for all other materials

Radiation exposure data and other derived parameters can be obtained at any location inside the nuclear reactor model. The computational system of the present invention allows the user to specify the spatial location in a Cartesian grid for every material or component such as pressure vessel welds and plates. Future exposure parameters and derived quantities can be calculated and projected based on user-provided assumptions about future operation of the plant. Further, the Materials Analysis Module can calculate the location of maximum exposure for each material or component defined by the user. Thus, in one embodiment, the material analyzer module can be customized for a specific nuclear reactor to include a set of reactor materials of interest.

Embedded within the Materials Analysis Module are equations to calculate radiation-induced embrittlement in accordance with the Code of Federal Regulations 10 CFR 50.61 and 10 CFR 50.61a. In addition, the Materials Analysis Module can calculate Through-Wall Cracking Frequency (“TWCF”). Available radiation exposure parameters include Fast Neutron Fluence (E>1.0 MeV), iron Displacements per Atom (“DPA”), and Stainless Steel Heat Generation Rates. In one embodiment, the Materials Analysis Module informs the user when the Fast Neutron Fluence (E>1.0 MeV) or RT-PTS quantity exceeds user-specified limits, which can be set to established regulatory limits.

The user can assess the data in various forms. In alternate embodiments of the present invention, the user can access the data in tabular format or in the form of a plot, which are automatically generated in accordance with the present invention.

The input data for use in the Materials Analysis Module includes the following:
Neutron and gamma flux radiation fields from the Radiation Transport Module;
Definition of the spatial position and extent of each material including radial position from the centerline of the reactor model (Rₘᵢₙ and Rₘₐₓ), azimuthal position (Tₘᵢₙ and Tₘₐₓ), and axial position (Zₘᵢₙ and Zₘₐₓ);
Radial position of the reactor pressure vessel clad-base metal interface; and
Total projection time, e.g., 60 effective full power years, for each projection requested by the user.

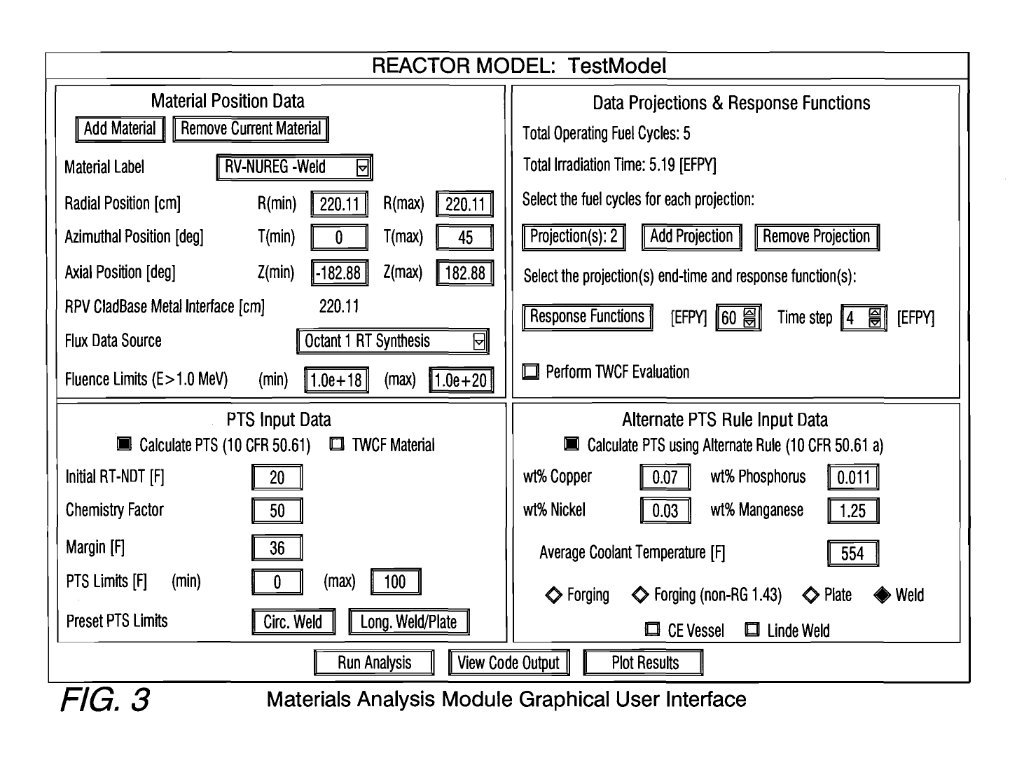

The above-described input data can be entered into the Materials Analysis Module using a variety of user-friendly mechanisms known in the art. In one embodiment, a graphical user interface, as shown in FIG. 3, can be used.

The output from the Materials Analysis Module includes tabular and graphics data of the following information:
Projected neutron fluence, DPA, RT-PTS data at a future time as specified by the user in the input phase;
Maximum exposure levels for each material that is defined by the user for each fuel cycle and for each future year of operation; and
An indication of the maximum exposure limits reached by each material (if the limit is reached), and the limits reached on the RT-PTS curves.

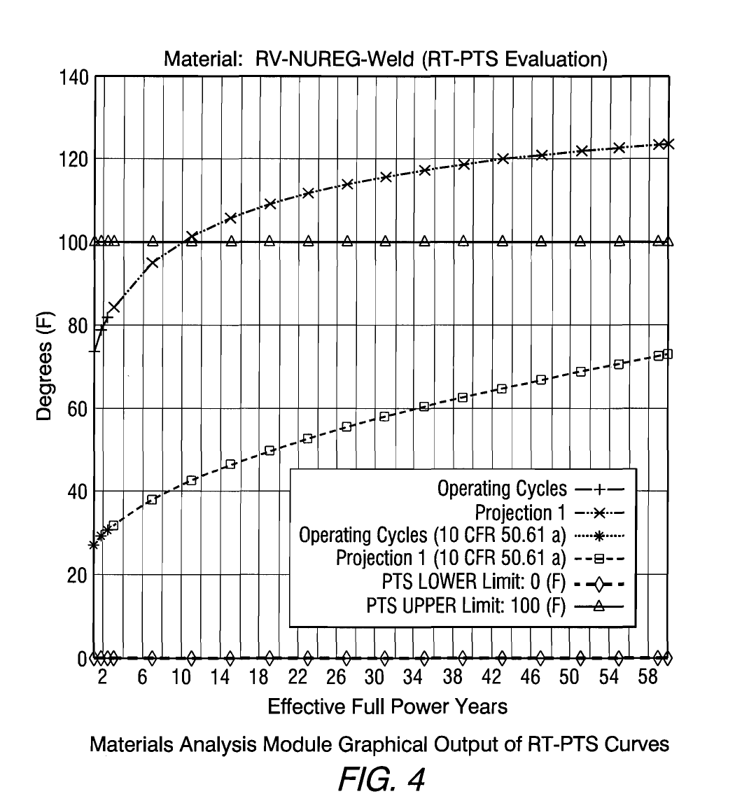

The Materials Analysis Module can present the output data which it generates in graphical format as shown in FIG. 4.

The three-dimensional Contour Plots Module generates three-dimensional contour plots of the radiation field and associated quantities. In general, this module generates complex images using the data generated from the Radiation Transport Module and from the Materials Analysis Module. In one embodiment, a set of binary files are generated for input into scientific visualization tools which are commercially available. The input data for use in the three-dimensional Contour Plots Module can include the following:
Transport calculations library for each fuel cycle generated by the Radiation Transport Module;
Data similar to that used as input to the Materials Analysis Module;
Response function, e.g., DPA and fluence;
Identified components for inclusion in the plot, e.g., core barrel and lower core plates; and
Identified fuel cycles to be plotted.

The output generated from the three-dimensional Contour Plots Module includes full-color 3-D contour plots of the response functions calculated according to Equation 2, components, and time intervals of interest.

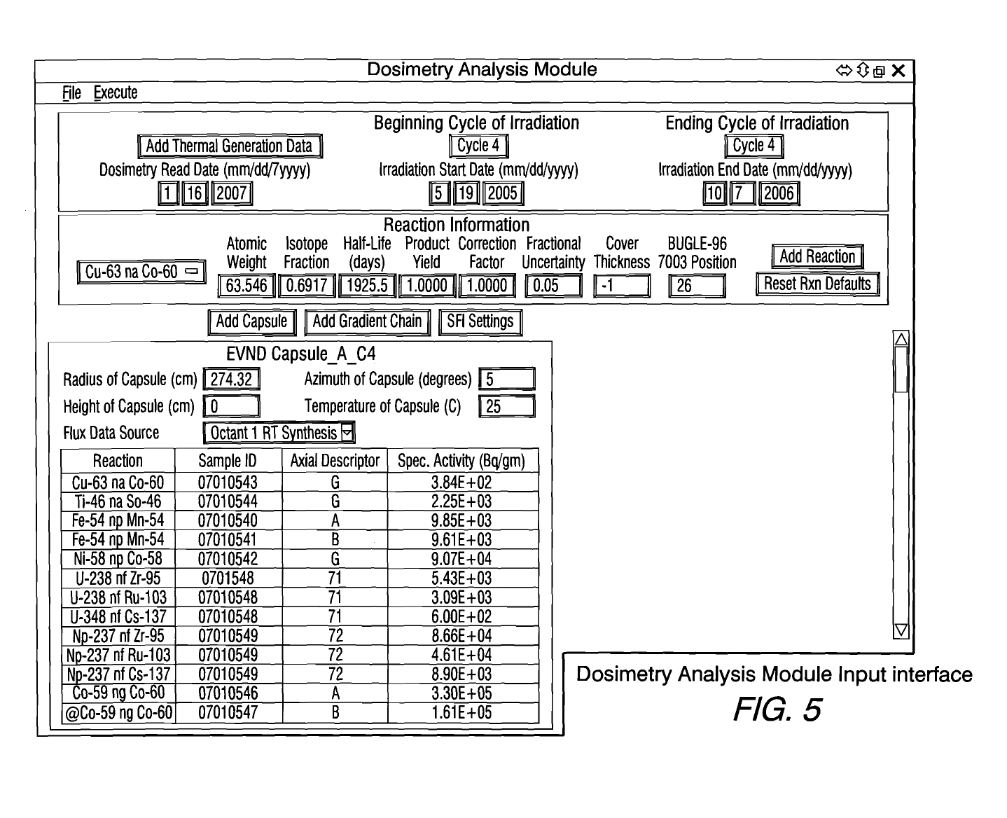

The Dosimetry Analysis Module allows a user to input measurement data (as shown, for example, in FIG. 5) from reactor dosimetry (in-vessel surveillance capsules or ex-vessel neutron dosimetry) and automatically performs a comparison of measured data to the radiation transport calculations. The comparison of measured and calculated data is then used to confirm or improve the confidence in the results from the radiation transport calculation.

The input data for the Dosimetry Analysis Module can include the following information:
Transport calculations library for each fuel cycle generated by the Radiation Transport Module;
Beginning/ending cycle of irradiation;
Dosimetry read date;
Dosimetry irradiation start/end date; and
Atomic weight, isotopic fraction, half-life, product yield, correction factor, fractional uncertainty, and cover thickness for each neutron reaction.

The output data produced by the Dosimetry Analysis Module includes a comparison of the calculated reaction rate using Equation (3) with the measured dosimetry value.

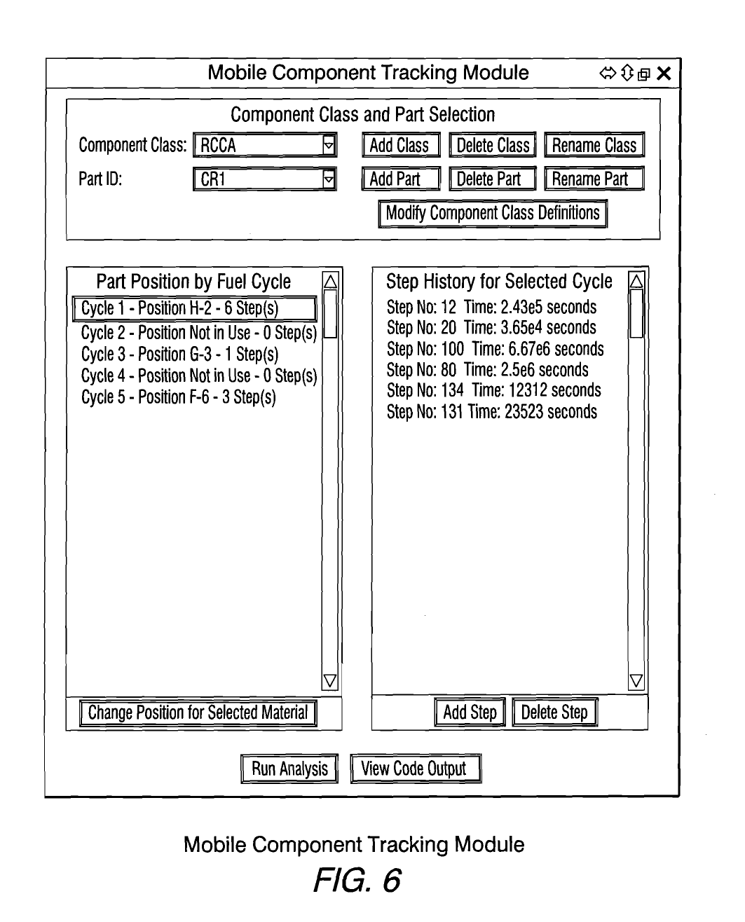

The Mobile Component Tracking Module calculates radiation exposure parameters for nuclear reactor components which do not remain in the same location between or within fuel cycles. Non-limiting examples of such reactor components include, but are not limited to, control rod assemblies and fuel assembly thimble plugs. The specific radiation exposure history for individual parts is tracked as the parts are moved around the reactor vessel (or optionally withheld from irradiation). See, for example, FIG. 6. Within each fuel cycle, the Mobile Component Tracking Module can accommodate unlimited part movement according to an integer number of “steps” along a user-specified vector. Available exposure data includes Fast Neutron Fluence (E>1.0 MeV), Thermal Neutron Fluence (E<0.414 eV), and other important response functions.

The input data for use in the Mobile Component Tracking Module can include the following:
Transport calculations library for each fuel cycle generated by the Radiation Transport Module; and
Data from the Materials Analysis Module specifying the component of interest (for example, if neutron exposure is tracked on a control rod, the spatial location of the control rod inside the reactor model is provided along with the historical record of its movement inside the reactor).

The output data produced by the Mobile Component Tracking Module includes the history of the exposure data, e.g., neutron fluence, for each position occupied by the component of interest, such as the control rod assemblies and/or the fuel assembly thimble plugs.

While the invention has been described in terms of various specific embodiments, those skilled in the art will recognize that the invention can be practiced with modifications within the spirit and scope of the appended claims.

1. A computational system to analyze a radiation field in a light water nuclear reactor, comprising:
a radiation transport module to perform a neutron and gamma transport calculation of a reactor geometry model of said light water nuclear reactor for at least one fuel cycle;
a material analysis module to analyze flux data calculated by the radiation transport module for materials and/or components within said light water nuclear reactor; and
a mobile component tracking module to calculate radiation exposure for components within said light water nuclear reactor which have more than one different location during or between the at least one fuel cycle.

2. The system of claim 1, wherein the Linear Boltzmann Equation is solved by the radiation transport module.

3. The system of claim 2, wherein the Equation is solved using an approach selected from the group consisting of a three-dimensional synthesis, a two-dimensional synthesis, and an explicitly three-dimensional formulation.

4. The system of claim 1, wherein data generated by the radiation transport module is electronically stored.

5. The system of claim 4, wherein the electronically stored data is accessible for use in projected fuel cycles.

6. The system of claim 1, wherein inputs are entered into said system using a graphical interface.

7. The system of claim 1, wherein the radiation transport module determines a spatial distribution of neutron and gamma flux radiation fields.

8. The system of claim 1, wherein the material analysis module calculates the location of maximum exposure for each specified material or component.

9. The system of claim 1, further comprising a three-dimensional contour plots module to generate three-dimensional contour plots of the radiation field using data generated from the radiation transport and materials analysis modules.

10. The system of claim 1, further comprising a dosimetry analysis module to compare measured data to the data generated by the radiation transport module.

11. The system of claim 1, wherein the mobile component tracking module calculates radiation exposure for a component selected from the group consisting of control rod assemblies and fuel assembly thimble plugs.

12. The system of claim 1, wherein the light water nuclear reactor is selected from the group consisting of pressurized water reactors and boiling water reactors.

13. A computational method for analyzing a radiation field in a light water nuclear reactor, comprising:
performing a neutron and gamma transport calculation of a reactor geometry model of said light water nuclear reactor for at least one fuel cycle;
analyzing flux data calculated by the neutron and gamma transport calculation for materials and/or components within said light water nuclear reactor; and
calculating radiation exposure for components within said light water nuclear reactor which have more than one different location during or between the at least one fuel cycle.

14. A computational method for integrating radiation transport methodologies to produce radiation exposure data for a light water nuclear reactor, comprising:
performing a neutron and gamma transport calculation of a reactor geometry model of said light water nuclear reactor for at least one fuel cycle;
analyzing flux data calculated by the neutron and gamma transport calculation for materials and/or components within said light water nuclear reactor; and
calculating radiation exposure for components within said light water nuclear reactor which have more than one different location during or between the at least one fuel cycle.
